(19) United States
(12) Patent Application Publication
(10) Pub. No.: US 2017/0108956 A1
(43) Pub. Date: Apr. 20, 2017

(54) CAPACITIVE STYLUS

(71) Applicant: WALTOP INTERNATIONAL CORPORATION, Hsinchu City (TW)

(72) Inventors: YING-HWA TANG, Hsinchu City (TW); YI-CHIH CHANG, Hsinchu City (TW)

(21) Appl. No.: 14/983,906

(22) Filed: Dec. 30, 2015

(30) Foreign Application Priority Data
Oct. 20, 2015 (TW) 104134279

(51) Int. Cl. G06F 3/0354

(52) U.S. Cl. CPC G06F 3/03545

(57) ABSTRACT

A capacitive stylus is disclosed. The capacitive stylus comprises an elastomer and a sensor holder, which can effectively buffer and disperse the impact transmitted from a nib so as to protect internal components of the capacitive stylus.

### CROSS-REFERENCE TO RELATED APPLICATIONS

The entire contents of Taiwan Patent Application No. 104134279, filed on Oct. 20, 2015, from which this application claims priority, are expressly incorporated herein by reference.

1. Field of the Invention

The present invention relates to a capacitive stylus, and more particularly to a capacitive stylus with an effective design for buffering and dispersing impact.

2. Description of the Prior Art

Capacitive touch input technology is widely used in the touch panel, one of advantages is allowing user to proceed input operation via user's hand or a contact object so as to have a multi touch function which can generate a variety of applications according to specific corresponding operations by various gestures. However, user's gestures are not suitable for a more delicate writing input operation, such as the writing input operations with stroke thickness changes. Moreover, input operation by using user's hand also lacks various functions. Thus a capacitive stylus instead of user's hand is used to perform exquisite input operation upon a touch panel with a capacitive touch input function.

The invention provide a capacitive stylus with an effective design for buffering and dispersing impact which can allow an user to initiate touch panel input operation by a handheld way so as to meet the requirements of proceeding exquisite and multifunctional writing input operation on a touch panel and to effectively buffer and disperse the impact applied upon a nib of the capacitive stylus to protect internal components of the capacitive stylus.

### SUMMARY OF THE INVENTION

An object of the present invention is to provide a capacitive stylus with an effective design for buffering and dispersing impact, which can effectively buffer and disperse the impact introduced by a nib of the capacitive stylus to protect internal components of the capacitive stylus.

According to the object, one embodiment of the present invention provides a capacitive stylus. The capacitive stylus comprises a conductive nib, a nib holder, a pressure sensor holder, a pressure sensor and a sensor board, an elastomer and a control circuit board. The conductive nib penetrates and combines with the nib holder, one end of the elastomer penetrates the nib holder, and the pressure sensor is on the sensor board. The elastomer comprises a circular configuration and a cone fore end, the cone fore end penetrates into the pressure sensor holder to contact the pressure sensor. The pressure sensor detects a tip pressure applied upon the capacitive stylus through the conductive nib pressing the pressure sensor via the elastomer. The sensor board electrically connects to the control circuit board to calculate a tip pressure value applied upon the capacitive stylus.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1A is a schematic view of a capacitive stylus according to one embodiment of the invention.

FIG. 1B is a schematic interior view of a capacitive stylus according to one embodiment of the invention.

FIG. 2 is a schematic cross sectional view of the capacitive stylus shown in FIGS. 1A and 1B according to one embodiment of the invention.

FIG. 2A is a schematic cross sectional view of the capacitive stylus according to one embodiment of the invention.

FIG. 2B shows an elastomer 116a of this embodiment.

FIG. 3A is a schematic cross sectional view of the capacitive stylus according to another embodiment of the invention.

FIG. 3B shows an elastomer 116b of this embodiment.

FIG. 4A is a schematic cross sectional view of the capacitive stylus according to another embodiment of the invention.

FIG. 4B shows an elastomer 116c of this embodiment.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in detail, it is appreciated that the scale of each component may not be expressly exactly.

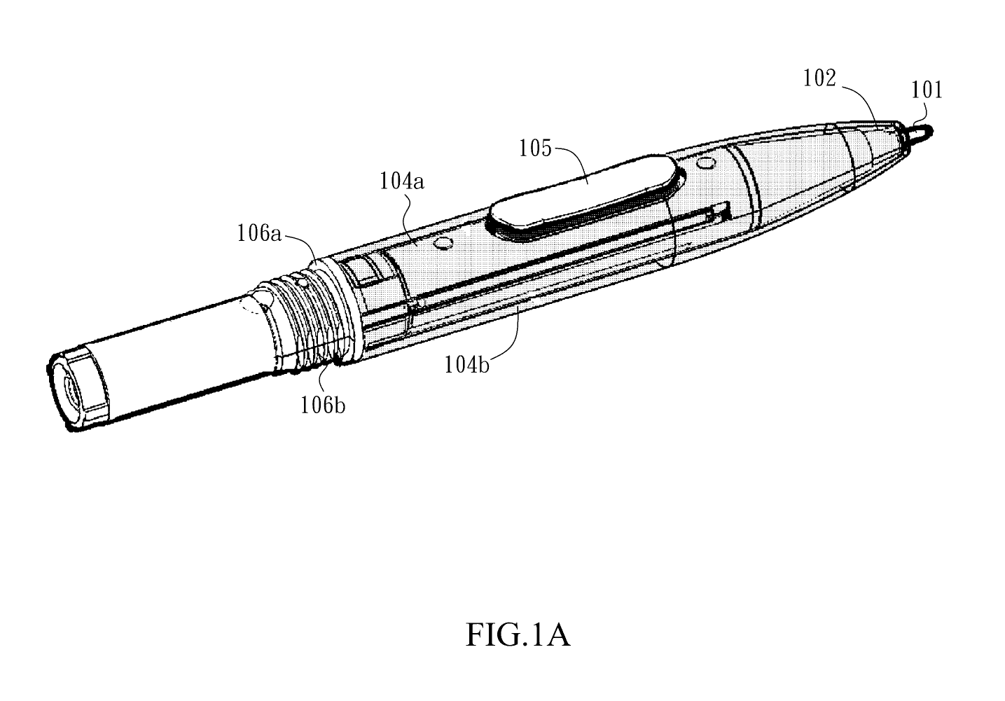

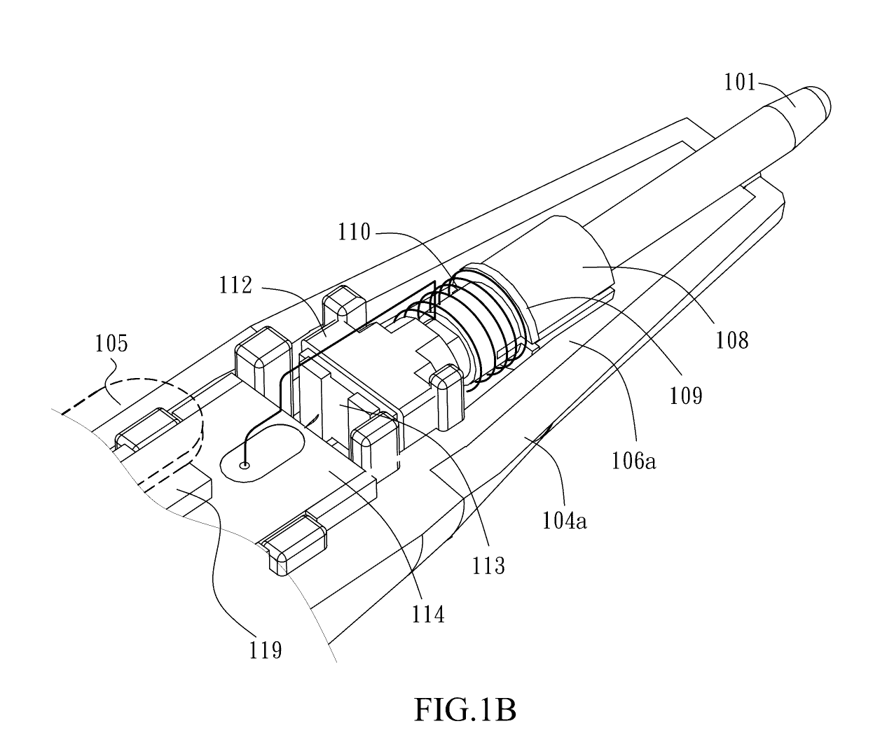

FIG. 1A is a schematic view of a capacitive stylus according to one embodiment of the invention. In this embodiment, a capacitive stylus comprises a conductive nib 101, a front tube 102, an upper shield 104a and a lower shield 104b, a button 105, an upper frame 106a and a lower frame 106b.

The conductive nib 101 comprises a replaceable conductive nib. The material of the conductive nib 101 comprises metals or any suitable electrical conductive materials. The front tube 102 can be combined with a rear tube (not shown). The upper shield 104a and the lower shield 104b are combined to shield the conductive nib 101 from environment noises to prevent signals transmitted by the capacitive stylus from being interfered. The materials of the upper shield 104a and the lower shield 104b comprise any suitable electrical conductive materials, but preferably metals. The button 105 is configured to allow user to operate switches on a control circuit board to select, turn on or off various functions of the capacitive stylus. The upper frame 106a and the lower frame 106b are configured to combine to secure the control circuit board, the conductive nib 101 and other components. More details about functions and operations of the components of the embodiment will be further described in the following contents.

FIG. 1B is a schematic interior view of a capacitive stylus according to one embodiment of the invention. The capacitive stylus further comprises a nib holder 108, a washer 109, a spring 110, a pressure sensor holder 112, a sensor board 113 and a control circuit board 114 in addition to the conductive nib 101, the front tube 102, the upper shield 104a and the lower shield 104b, the button 105, the upper frame 106a and the lower frame 106b.

The nib holder 108 is configured to secure and contact with the conductive nib 101. The material of the nib holder 108 comprises any suitable electrical conductive materials, but preferably metals. The spring 110 is configured to surround and contact with the nib holder 108 so as to connect the conductive nib 101 and the nib holder 108 to the control circuit board 114. The material of the spring 110 is preferably metal. The capacitive stylus outputs high voltage signals from the control circuit board 114 through the spring 110, the nib holder 108 and the conductive nib 101. The spring 110 is also configured to provide the conductive nib 101 with a retraction space so that the conductive nib 101 can recoil back to original position after the tip pressure applied on the conductive nib 101 vanishes. When a tip pressure is applied upon the conductive nib 101, the conductive nib 101 and the nib holder 108 compress the spring 110. The spring 110 pushes the conductive nib 101 and the nib holder 108 back to original position after the tip pressure is removed. The material of the washer 109 comprises acoustic absorbing materials, such as rubber. The washer 109 is used to diminish or lessen noises resulting from the movements of the nib holder 108 and the spring 110. The pressure sensor holder 112 is configured to secure a pressure sensor 118. More details about functions and operations of the components of the embodiment will be further described in the following contents.

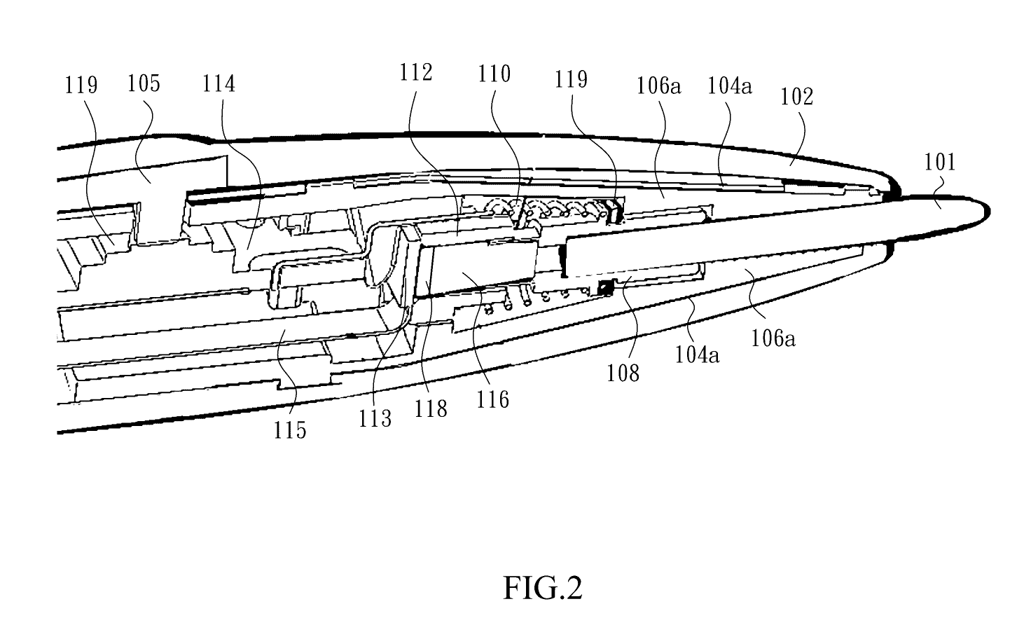

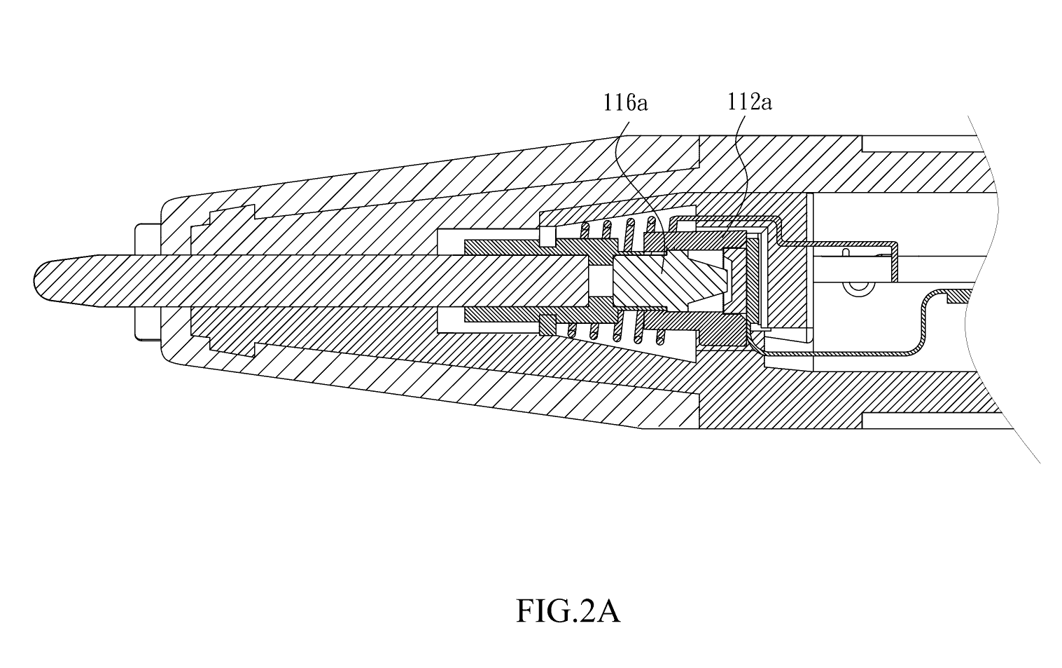

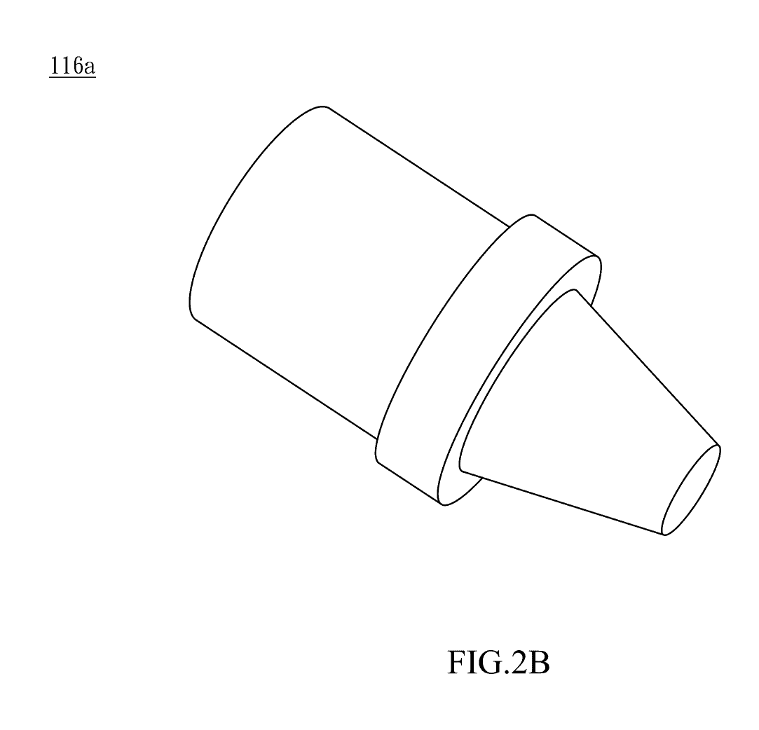

FIG. 2 is a schematic cross sectional view of the capacitive stylus shown in FIGS. 1A and 1B according to one embodiment of the invention. As shown in FIG. 2, one end of the conductive nib 101 is sheathed into one end of the nib holder 108 while the other end of the conductive nib 101 extends out from the capacitive stylus. The spring 110 surrounds and contacts with the nib holder 108 and connects the conductive nib 101 and the nib holder 108 to the control circuit board 114. The washer 109 is located on the nib holder 108. The conductive nib 101, the nib holder 108 and the spring 110 are electrically connected to the control circuit board 114 so that the high voltage signals of the capacitive stylus can be transmitted from the control circuit board 114 through the spring 110, the nib holder 108 and the conductive nib 101. One end of an elastomer 116 is sheathed into the other end of the nib holder 108 while the other end of the elastomer 116 is toward the pressure sensor 118 and sheathed into the pressure sensor holder 112. The material of the elastomer 116 comprises, but not limited to, rubber. The pressure sensor 118 is configured to be located on the sensor board 113 and is secured by the pressure sensor holder 112. The pressure sensor 118 sends signals to the control circuit board 114 via a flexible printed circuit board 115 which connects the sensor board 113 to the control circuit board 114 so as to calculate tip pressure values of the capacitive stylus. When a tip pressure is applied upon the conductive nib 101, the nib holder 108 which is combined with the conductive nib 101 applies a pressure upon the pressure sensor 118 through the elastomer 116. The pressure sensor 118 then sends signals corresponding to the tip pressure to the control circuit board 114 via the flexible printed circuit board 115 so as to calculate the tip pressure value of the capacitive stylus. The button 105 is used to operate a switch 119 on the control circuit board 114 to select, turn on or off various functions of the capacitive stylus. The upper frame 106a and the lower frame 106b are configured to combine to secure the conductive nib 101, the nib holder 108, the spring 110, the pressure sensor holder 112, the sensor board 113, and the control circuit board 114. The upper shield 104a and the lower shield 104b are configured to combine to surround portions of the upper frame 106a and the lower frame 106b.

FIG. 2A is a schematic cross sectional view of the capacitive stylus according to one embodiment of the invention. FIG. 2B shows an elastomer 116a of this embodiment. In this embodiment, a pressure sensor holder 112a and the elastomer 116a are designed as a combination to decrease and disperse impact induced by the conductive nib 101. For example, when the capacitive stylus falls from a high position and the conductive nib 101 suffers direct impact, the pressure sensor holder 112a and the elastomer 116a must lessen and disperse the impact introduced by the conductive nib 101 effectively so as to protect components inside the capacitive stylus. In this embodiment, the elastomer 116a comprises a circular configuration and a cone fore end. The cone fore end penetrates into the pressure sensor holder 112a to contact the pressure sensor 118. When the conductive nib 101 suffers direct impact, the circular configuration is configured to sustain the impact while the cone fore end is configured to decrease and disperse the impact.

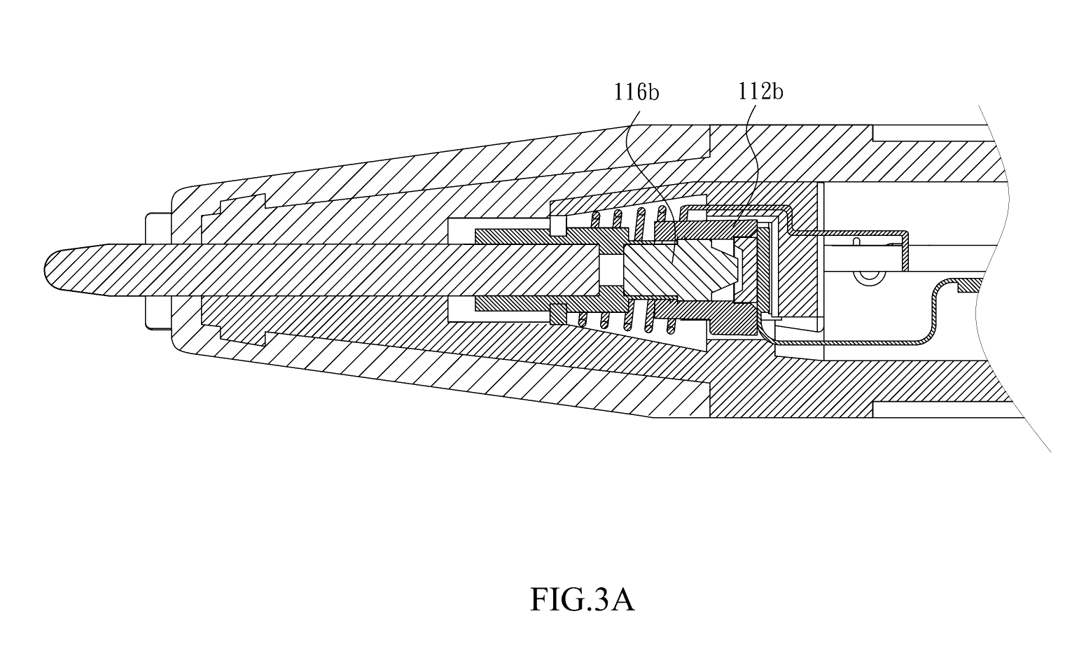

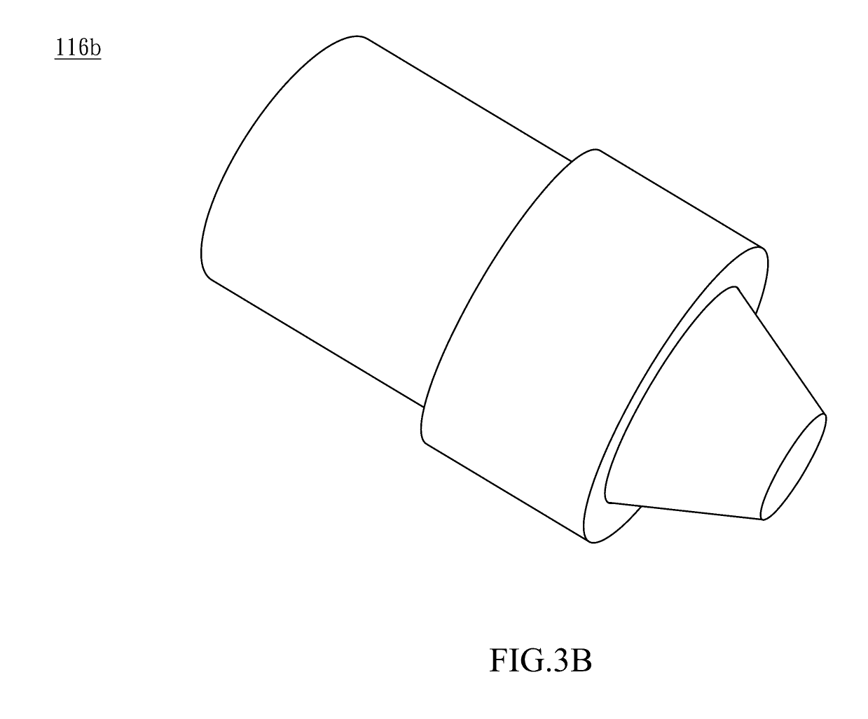

FIG. 3A is a schematic cross sectional view of the capacitive stylus according to another embodiment of the invention. FIG. 3B shows an elastomer 116b of this embodiment. In this embodiment, the circular configuration of the elastomer 116b has a thickness larger than that of the circular configuration of the elastomer 116a while the cone fore end of the elastomer 116b is shorter than that of the elastomer 116a comparing to the elastomer 116a shown in FIG. 2B.

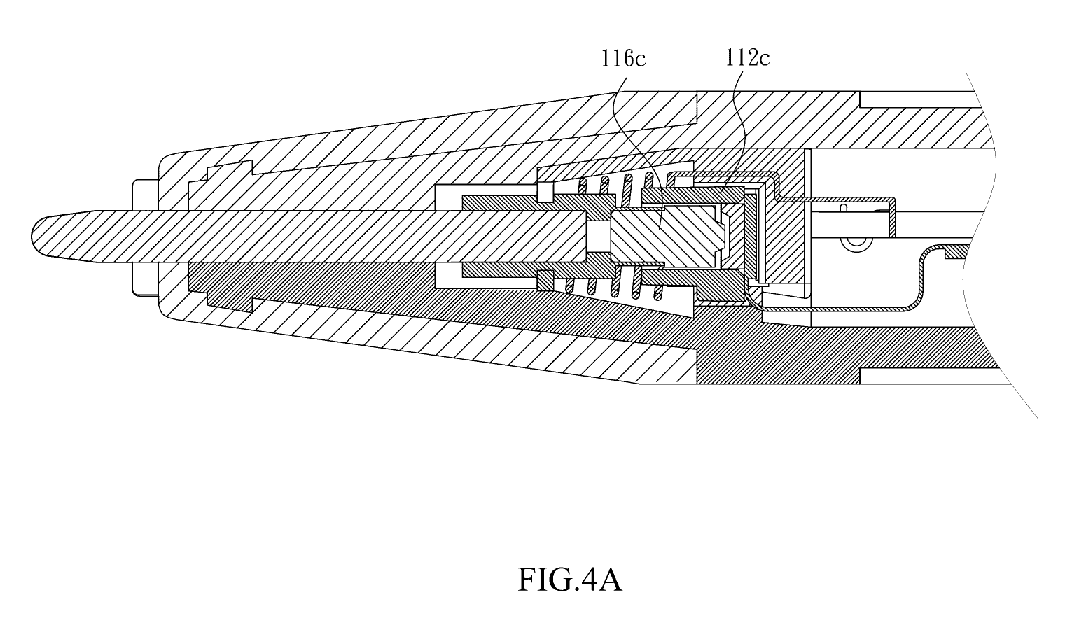

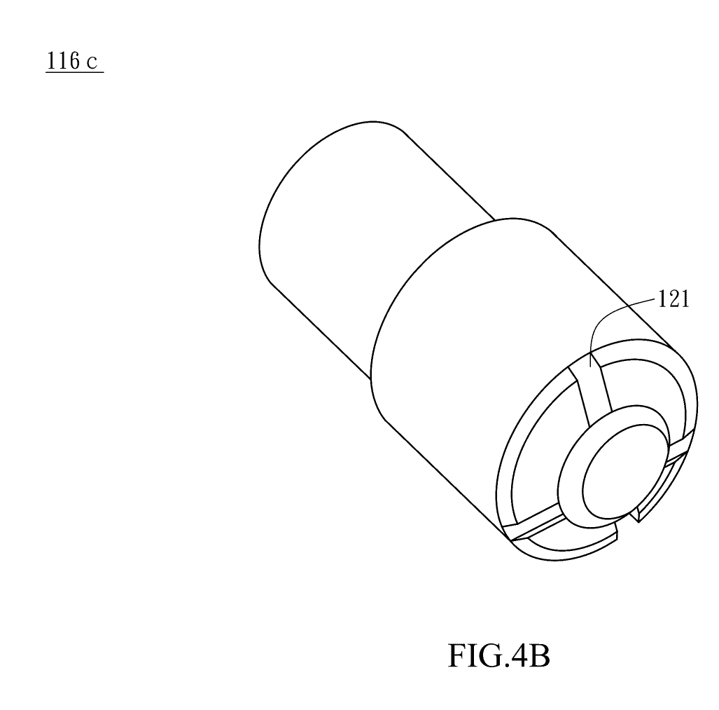

FIG. 4A is a schematic cross sectional view of the capacitive stylus according to another embodiment of the invention. FIG. 4B shows an elastomer 116c of this embodiment. In this embodiment, the elastomer 116c comprises a fore end and a circular configuration. The circular configuration comprises trenches on the top surface. When the elastomer 116c suffers impact and compresses, a confined space will be formed. When the elastomer 116c moves back, a vacuum suction is generated. Thus the impact introduced by the conductive nib 101 can be decreased and dispersed and the pressure sensor 118 can be protected from being damaged.

It is noted that the configuration, shape and material of the components of the embodiment mentioned above and shown are examples instead of limitations, any equivalents, alternatives or modifications of the embodiment corresponding to the spirit of invention should be encompassed in the scope of the invention. More details about connecting configurations, functions and operations of the components of the capacitive stylus according to embodiments of the invention which are known, appreciated and enabled by those with ordinary skill in the art are omitted herein.

Although specific embodiments have been illustrated and described, it will be appreciated by those skilled in the art that various modifications may be made without departing from the scope of the present invention, which is intended to be limited solely by the appended claims.

What is claimed is:

1. A capacitive stylus, comprising:
a conductive nib and a nib holder, the conductive nib penetrating and combining with the nib holder;
an elastomer, a pressure sensor holder, a pressure sensor and a sensor board, one end of the elastomer penetrating the nib holder, the pressure sensor being on the sensor board, the elastomer comprising a circular configuration and a cone fore end, the cone fore end penetrating into the pressure sensor holder to contact the pressure sensor, the pressure sensor detecting a tip pressure applied upon the capacitive stylus through the conductive nib pressing the pressure sensor via the elastomer; and
a control circuit board, the sensor board electrically connecting to the control circuit board to calculate a tip pressure value applied upon the capacitive stylus.

2. The capacitive stylus according to claim 1 further comprising a spring connecting to the nib holder so as to connect the conductive nib to the control circuit board through the nib holder.

3. The capacitive stylus according to claim 1 further comprising a washer on the nib holder to diminish or lessen noises resulting from the movements of the nib holder and the spring.

4. A capacitive stylus, comprising:
a conductive nib and a nib holder, the conductive nib penetrating and combining with the nib holder;
an elastomer, a pressure sensor holder, a pressure sensor and a sensor board, one end of the elastomer penetrating the nib holder, the pressure sensor being on the sensor board, the elastomer comprising a fore end and a circular configuration, the circular configuration comprising trenches on a top surface thereof, the circular configuration and the fore end contacting the pressure sensor, the pressure sensor detecting a tip pressure applied upon the capacitive stylus through the conductive nib pressing the pressure sensor via the elastomer; and
a control circuit board, the sensor board electrically connecting to the control circuit board to calculate a tip pressure value applied upon the capacitive stylus.

5. The capacitive stylus according to claim 4 further comprising a flexible printed circuit board connecting the sensor board to the control circuit board.

6. The capacitive stylus according to claim 4 further comprising a spring connecting to the nib holder so as to connect the conductive nib to the control circuit board through the nib holder.

7. The capacitive stylus according to claim 6 further comprising an upper frame and a lower frame, the upper frame and the lower frame being configured to combine to secure the conductive nib, the nib holder, the spring, the pressure sensor holder, the sensor board, and the control circuit board.

8. The capacitive stylus according to claim 7 further comprising an upper shield and a lower shield, the upper shield and the lower shield being configured to combine to surround portions of the upper frame and the lower frame.
